(19) United States
(12) Patent Application Publication
(10) Pub. No.: US 2024/0034259 A1
(43) Pub. Date: Feb. 1, 2024

(54) ASSEMBLY FOR ABSORBING IMPACT ENERGY

(71) Applicant: Valeo Systemes Thermiques, Le Mesnil-Saint-Denis (FR)

(72) Inventors: Sergio Da Costa Pito, Le Mesnil-Saint-Denis Cedex (FR); Ali Kezmane, Le Mesnil-Saint-Denis (FR)

(73) Assignee: Valeo Systemes Thermiques, Le Mesnil-Saint-Denis (FR)

(21) Appl. No.: 18/257,012

(22) PCT Filed: Dec. 3, 2021
(86) PCT No.: PCT/EP2021/084292

§ 371 Date: Jun. 12, 2023

(30) Foreign Application Priority Data
Dec. 10, 2020 (FR) FR2013010

(51) Int. Cl. B60R 19/34; B60R 19/03; F16F 7/12; F16F 7/00

(52) U.S. Cl. CPC B60R 19/34; B60R 19/03; F16F 7/124; F16F 7/003; F16F 2224/0241; F16F 2226/042; F16F 2226/048; F16F 2236/04

(57) ABSTRACT

The invention relates to an assembly (10) for absorbing impact energy, comprising a bumper beam and at least one energy absorbing device (1), interposed between this bumper beam (2) and a side member (3) of a motor vehicle, this energy absorbing device, also referred to as a crashbox, comprising a body comprising a plastic material and at least one insert (12) made from composite material comprising a plastic material and a reinforcing filler embedded in this plastic material of the insert, the plastic body and the composite insert being connected in particular by welding, bonding, thermoforming, the insert comprising a region of mechanical weakness (15) arranged to help initiate the breaking of the absorbing device.

The present invention relates to an assembly for absorbing impact energy that is suitable for providing protection in the event of an impact, in particular a frontal impact, to a motor vehicle.

In order to absorb the energy of an impact, in particular a frontal impact, to a bumper beam of a motor vehicle, it is known practice to use energy-absorbing devices that deform due to the forces exerted by the impact. These energy-absorbing devices are generally made of a metal material due to their strength thereof. However, these metal energy-absorbing devices are heavy and are not in line with the evolution of motor vehicles, which are intended to become increasingly lightweight.

In particular, the present invention aims to improve an assembly for absorbing impact energy that is suitable for providing protection in the event of an impact, in particular a frontal impact, to a motor vehicle.

One subject of the present invention is therefore an assembly for absorbing impact energy, comprising a bumper beam and at least one energy-absorbing device, interposed between this bumper beam and a side rail of a motor vehicle, this energy-absorbing device, which is also referred to as a crashbox, comprising a body comprising a plastics material and at least one insert made of a composite material comprising a plastics material and a reinforcing filler embedded in this plastics material of the insert.

For example, the plastic body and the composite inserts are joined, in particular by overmolding with a material that is of the same nature or is compatible.

The insert preferably comprises a region of mechanical weakness that is arranged to promote initiation of the energy-absorbing device breaking.

The invention therefore makes it possible, in particular in the event of a frontal impact, to absorb the maximum amount of impact energy throughout the impact without thereby reaching a force peak, in a manner that does not damage the part of the vehicle behind the bumper. In the event of an accident and of an impact, the repair costs can therefore be reduced.

The presence of a region of weakness makes it possible, by acting as a breaking initiator, to avoid/reduce the force peak that could occur in the event of an accidental impact.

The implementation of the invention does not entail any additional cost and may easily be carried out in a production plant.

According to one of the aspects of the invention, the region of weakness in the insert comprises a slot formed on the insert.

According to one of the aspects of the invention, the slot is empty. In other words, this slot corresponds to a hole in the insert.

According to one of the aspects of the invention, the slot receives a filling material, in particular a plastics material.

For example, this filling material is the same as that used for overmolding, which is in particular compatible with the composite material. For example, this material is PP, PA6, PC or PBT.

According to one of the aspects of the invention, the filling material is different than the material used for the rest of the insert.

According to one of the aspects of the invention, the thickness of the filling material is smaller than the thickness of the insert.

According to one of the aspects of the invention, the slot has any round, polygonal or curved shape.

According to one of the aspects of the invention, each insert has a single region of weakness.

As a variant, each insert has a plurality of regions of weakness, in particular a plurality of slots.

For example, the slot has an elongate shape.

According to one of the aspects of the invention, the insert is formed from a sheet of composite material.

According to one of the aspects of the invention, the reinforcing filler of the insert comprises glass fibers.

According to one of the aspects of the invention, the filling material of the slot can be the same as the plastics material of the body.

According to one of the aspects of the invention, the body comprises reinforcing ribs, which are in particular formed by molding the plastics material.

According to one of the aspects of the invention, a plurality of inserts are provided on the body.

According to one of the aspects of the invention, the number of inserts on each body is chosen to be between 2 and 10, for example between 2 and 6, for example being 6.

As a variant, a single insert is provided on each body.

According to one of the aspects of the invention, each insert is arranged between two reinforcing ribs of the body.

According to one of the aspects of the invention, the one or more inserts are arranged on the surface of the body of the energy-absorbing device.

According to one of the aspects of the invention, the body has a periphery, and the insert extends only over a sector of this periphery. In other words, the insert is not a rolled-up strip with its two ends joined together.

Another subject of the invention is an energy-absorbing device comprising a body comprising a plastics material and at least one insert made of a composite material comprising a plastics material and a reinforcing filler embedded in this plastics material of the insert, the plastic body and the composite insert being joined, in particular by welding, adhesive bonding or thermoforming.

The abovementioned plastics material may be polypropylene (PP), high-density polyethylene (HDPE), polyamide (PA), a polycarbonate/polybutylene terephthalate (PC/PBT) alloy, polycarbonate (PC), an acrylate, a polyurethane or a thermoplastic (TPU).

Further features, details and advantages of the invention will become more clearly apparent upon reading the detailed description given below, and from several exemplary embodiments that are given by way of nonlimiting indication, with reference to the attached schematic drawings, in which:

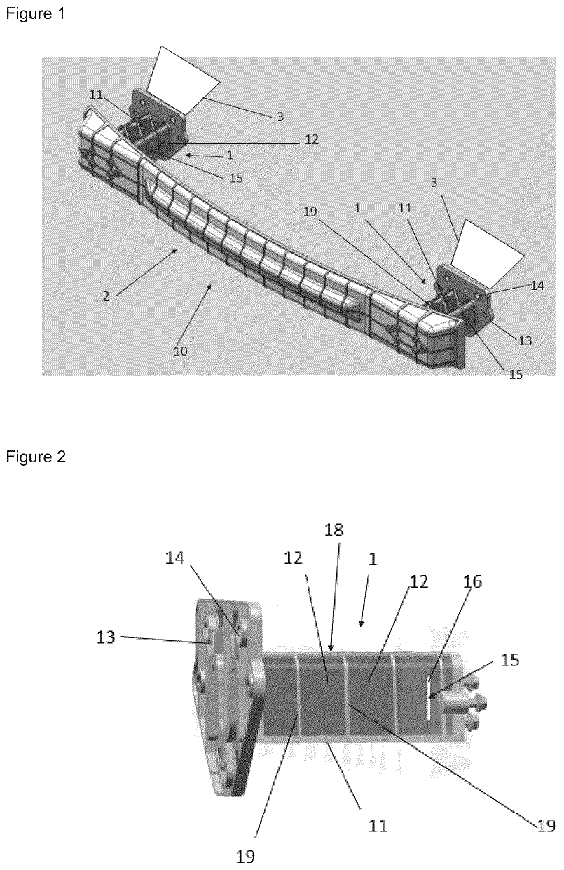

FIG. 1 is a schematic view of an assembly according to one example of the invention,

FIG. 2 schematically and partially shows a detail of the assembly according to FIG. 1.

Motor vehicles are generally fitted with a bumper beam 2 arranged on the front face. As shown in FIG. 1, this bumper beam 2 may be attached to two side rails 3 of the vehicle. In order to absorb impacts and to prevent the energy from the impacts from being directly transmitted to the side rails 3 and to the rest of the vehicle, the bumper beam 2 is attached to energy-absorbing devices 1, which connect the bumper beam 2 and the ends of the side rails 3 facing said bumper beam 2.

FIG. 1 shows an assembly 10 for absorbing impact energy, comprising the bumper beam 2 and, at two locations on the bumper 2, the two energy-absorbing devices 1, which are each interposed between this bumper beam 2 and the associated side rail 3.

Each energy-absorbing device 1, which is also referred to as a crashbox, comprises a body 11 comprising a plastics material and inserts 12 made of a composite material comprising a plastics material and a reinforcing filler embedded in this plastics material of the insert.

For example, the inserts 12 comprise carbon fibers and/or glass fibers, this reinforcing material being incorporated into the plastics material. This plastics material may be polypropylene (PP), high-density polyethylene (HDPE), polyamide (PA), a polycarbonate/polybutylene terephthalate (PC/PBT) alloy, polycarbonate (PC), an acrylate, a polyurethane or a thermoplastic (TPU).

The inserts 12 are formed from a sheet.

The body 11 is manufactured from a plastics material, which may be polypropylene (PP), high-density polyethylene (HDPE), polyamide (PA), a polycarbonate/polybutylene terephthalate (PC/PBT) alloy, polycarbonate (PC), an acrylate, a polyurethane or a thermoplastic (TPU).

The plastic body 11 is overmolded onto the inserts 12. The plastic used for the overmolding is of the same nature as, or is chemically compatible with, the resin that impregnates the composite material of the inserts, so as to ensure strong adhesion between the body 11 and the inserts 12.

The body 11 comprises a mounting plate 13, formed in one piece with the rest of the body 11, for attaching to the side rail 3. This mounting plate 13 comprises holes 14 for attachment means, such as screws, for attaching to the side rail 3.

Each insert 12 comprises one or more regions of mechanical weakness 15 that are arranged to promote initiation of the energy-absorbing device 1 breaking.

Each region of weakness 15 in the insert comprises a slot 16 formed in the insert.

In the example described, the slots 16 in the regions 15 are empty. In other words, each slot 16 corresponds to a hole in the insert.

In one variant, the slot 16 receives a filling material, in particular a plastics material.

The filling material is different than the material used for the rest of the insert 12.

The thickness of the filling material is smaller than the thickness of the insert 12.

Each slot 16 has any round, polygonal or curved shape.

One of the inserts may have a single region of weakness 15 or a plurality of regions of weakness 15, which are thus formed by a plurality of slots. This number may be two, three or more.

The insert 12 that can be seen in FIG. 2 comprises just one region of weakness 15.

For example, the slot 16 has an elongate shape.

Each insert 12 is formed from a sheet of composite material.

Each body 11 comprises reinforcing ribs 19 formed by molding the plastics material. These ribs 19 may be arranged in the shape of a cross, or another pattern.

The number of inserts on each body is chosen to be between 2 and 10, for example between 2 and 6, for example being 6.

For example, each insert 12 is arranged between two reinforcing ribs 19 of the body 11, as can be seen in FIG. 2, for example.

Each insert 12 is arranged on the surface of the body 11 of the energy-absorbing device, bearing on ribs 19 that are located below this insert 12.

The plastic body 11 has a periphery 18, and each insert 12 extends only over a sector of this periphery 18. In other words, the insert 12 is not a rolled-up strip with its two ends joined together.

The inserts 12 may all be identical or, as a variant, be different such that inserts 12 have different shapes, optionally with a number of regions of weakness that varies from one insert to the next.

1. An assembly for absorbing impact energy, comprising;
a bumper beam; and
at least one energy-absorbing device interposed between the bumper beam and a side rail of a motor vehicle,
the energy-absorbing device, which is also referred to as a crashbox, comprising a body comprising a plastics material and at least one insert made of a composite material comprising a plastics material and a reinforcing filler embedded in the plastics material of the insert, the plastic body and the composite insert being joined, the insert comprising a region of mechanical weakness that is arranged to promote initiation of the absorbing device breaking.

2. The assembly as claimed in claim 1, wherein the region of weakness in the insert comprises a slot formed on the insert.

3. The assembly as claimed in claim 2, wherein the slot is empty.

4. The assembly as claimed in claim 2, wherein the slot receives a filling material.

5. The assembly as claimed in claim 2, wherein the slot has any round, polygonal or curved shape.

6. The assembly as claimed in claim 1, wherein the insert is formed from a sheet of composite material.

7. The assembly as claimed in claim 1, wherein the body comprises reinforcing ribs, which are formed by molding the plastics material.

8. The assembly as claimed in claim 1, wherein a plurality of inserts are provided on the body.

9. The assembly as claimed in claim 1, wherein the body has a periphery, and the insert extends only over a sector of this periphery.

10. An energy-absorbing device comprising;
a body comprising a plastics material; and
at least one insert made of a composite material comprising a plastics material and a reinforcing filler embedded in the plastics material of the insert,
the plastic body and the composite insert being joined by welding, adhesive bonding or thermoforming.
